(19) United States
(12) Patent Application Publication
(10) Pub. No.: US 2004/0186918 A1
(43) Pub. Date: Sep. 23, 2004

(54) Method and apparatus for dispatching incoming data in a multi-application terminal

(76) Inventors: Mikko Aleksi Lonnfors, Helsinki (FI); Jaakko Teinila, Espoo (FI); Jose Costa-Requena, Helsinki (FI); Jukka Immonen, Espoo (FI); Inmaculada Espigares, Helsinki (FI)

Correspondence Address: CRAWFORD MAUNU PLLC, Suite 390, 1270 Northland Drive, St. Paul, MN, 55120, US

(21) Appl. No.: 10/394,591

(22) Filed: Mar. 21, 2003

(51) Int. Cl. G06F 15/16

(52) U.S. Cl. 709/250; 709/206

(57) ABSTRACT

A method and apparatus for dispatching incoming application data on a computing device is disclosed. A dispatcher can determine a correct destination application for an incoming application data based on a registry and an application descriptor in the incoming data. In one arrangement, the dispatcher can be included as part of the Java Mobile Device Information Profile PushRegistry framework for handling incoming network connections. The dispatcher can be used in a multiple protocol environment, as well be used by multiple applications utilizing the same protocols.

### FIELD OF THE INVENTION

This invention relates in general to computing and communications devices, and more particularly to a method and apparatus for dispatching network data in a multi-application arrangement.

### BACKGROUND OF THE INVENTION

Personal communication devices are becoming more widely adopted by the public. Such devices as cellular phones, personal digital assistants, and laptop computers give users a variety of mobile communications and computer networking capabilities. These devices are increasingly able to communicate using a wide variety of digital multimedia formats, include voice, music, video, text messaging, etc.

One important standard that has allowed providing digital multimedia to mobile and other computing devices is the Session Initiation Protocol (SIP). SIP is a signaling protocol that assists digital devices in establishing end-to-end multimedia sessions, as well as providing other features such as presence and sending text and binary messages. SIP is an application level protocol for providing features such as those provided by the Public Switch Telephone Network (PSTN), but over digital networks using Internet protocols such as Transmission Control Protocol/Internet Protocol (TCP/IP).

SIP has a protocol structure similar to HTTP, in that it is a text based message protocol operating on a well known network port. From the terminal's perspective, SIP is different than HTTP because the terminal must have a listening process to be notified of incoming communications. In contrast, a web browser utilizing HTTP is purely a client—the browsers initiates connections to listening servers at the user's request, and does not listen for incoming connections.

SIP has been found to be useful in many different applications that can run on mobile or fixed terminals. The problem is that most systems are not easily adaptable to have more than one SIP aware application running at a time, since SIP applications typically require a server process that reserves a network port on the terminal. Another problem is that multiple applications could be interested on the same content type that is received via the same transport mechanism (SIP, HTTP, Wireless Session Protocol (WSP), etc). A similar problem exists with other network server applications that try to reserve network resources on a device. Although network applications can be configured to use any available network port, any hosts that may want to connect to the applications may not be aware of the port on which the application is listening.

Although this situation has been traditionally resolved by reserving a different, well-known network port for every new application, this approach has its limitations. Reserved ports are a finite resource, and the need to register a port can be burdensome on a developer of a small user program. Further, since many applications can be built upon top of existing protocols such as SIP, it is assumed that the default protocol ports will be used for this traffic.

What is needed an improved way to determine the appropriate user application for an incoming data message on a communications device. Such a solution should work with existing protocols and network ports and avoid contention among those ports. The present disclosure discusses these issues as well as other aspects of this technology.

### SUMMARY OF THE INVENTION

To overcome limitations in the prior art described above, and to overcome other limitations that will become apparent upon reading and understanding the present specification, the present disclosure describes a method and apparatus for dispatching incoming data on a networked computing device. In one embodiment, a method provides for processing an incoming network application data for a plurality of applications. The method involves communicating an application descriptor of each of the plurality of applications to a registry. The incoming application data is received at a network interface. A destination application from the plurality of applications is identified based on an application descriptor of the incoming application data and the registry. The incoming application data is communicated to the destination application.

In another embodiment of the present invention, a communications device includes a persistent data storage with an application descriptor registry and a network interface for receiving an incoming application data. A processor is arranged to receive the incoming application data from the network interface, identify a destination application of the communications device from the application descriptor registry and an application descriptor of the incoming application data, and communicate the incoming application data to the destination application.

In another embodiment of the present invention, a system for communicating an application data over a network includes a first computing device with a network interface coupled to the network for sending the application data. The system includes a second computing device having a persistent data storage with an application descriptor registry. A network interface of the second computing device is coupled to the network and configured to receive the application data. The second computing device includes a processor arranged to receive the application data from the network interface, identify a destination application of the second computing device based on the application descriptor registry and an application descriptor of the application data, and communicate the application data to the destination application.

The above summary of the present invention is not intended to describe each illustrated embodiment or implementation of the present invention. This is the purpose of the figures and the associated discussion which follows.

### BRIEF DESCRIPTION OF THE DRAWINGS

The invention is described in connection with the embodiments illustrated in the following diagrams.

FIG. 1 illustrates a representative system environment in which the principles of the present invention may be employed;

FIG. 2 is a diagram showing an apparatus utilizing a dispatcher and registry according to embodiments of the present invention;

FIG. 3 is a diagram of a Java enabled terminal adapted for dispatching incoming data according to embodiments of the present invention; and

FIG. 4 is a system diagram showing an example use of multiple client applications on a device according to embodiments of the present invention.

### DETAILED DESCRIPTION OF THE INVENTION

In the following description of the example embodiments, reference is made to the accompanying drawings which form a part hereof, and in which is shown by way of illustration various manners in which the invention may be practiced. It is to be understood that other embodiments may be utilized, as structural and operational changes may be made without departing from the scope of the present invention.

Generally, the present invention provides a method and apparatus for utilizing a shared message dispatcher for multiple client applications. The messages may use common or different protocols. The dispatcher allows a system to intelligently choose a destination client application for incoming data based on capabilities of the client applications. The dispatcher allows a client application to register the content type the application can receive and a list of protocols over which the application can communicate. Additional logic can be included that helps the dispatcher in discerning the right applications for incoming content where more than one application are expecting the same content type. The dispatcher may be a separately running application or be incorporated as part of an existing software architecture. The dispatcher is typically incorporated in a fixed or mobile digital communications device.

In general, digital communication devices are electronic apparatuses that can exchange data with other devices. The data can be transmitted through various communication mediums such as wire, optical fiber, or through the air as electromagnetic or light waves. Increasingly, communication devices include some sort of computing hardware such as a microprocessor. The growth of microprocessor controlled devices has been steadily growing in the field of mobile communication devices (cellular phones, PDAs, etc.). By and large, most mobile communications devices use microprocessors and can therefore be considered mobile data processing devices.

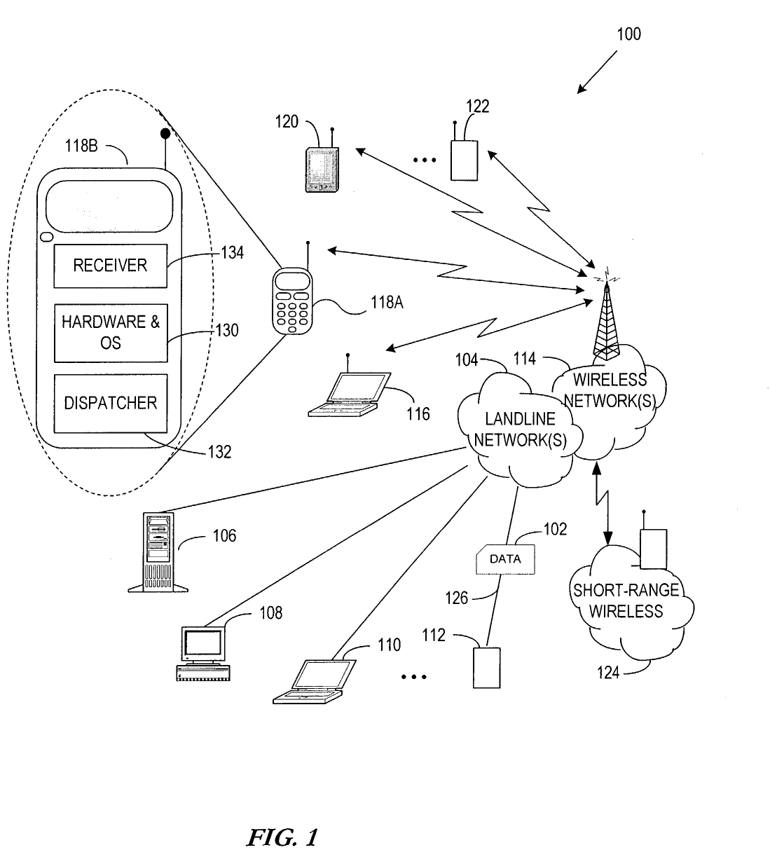

FIG. 1 illustrates a representative system environment 100 in which the principles of the present invention may be employed. In the representative system environment 100, messages 102 may be communicated between devices in any number of known manners. These manners include via a landline network(s) 104, which may include a Global Area Network (GAN) such as the Internet, one or more Wide Area Networks (WAN), Local Area Networks (LAN), and the like. Any computing device or other electronic device that supports messages 102 over SIP, HTTP, WSP or any other existing or future network protocols may be the target system that utilizes the present invention. These target systems include servers 106, desktop computers 108 or workstations, laptop or other portable computers 110, or any other similar computing device capable of communicating via the network 104, as represented by generic device 112.

The message 102 may be provided via one or more wireless networks 114, such as Global System for Mobile Communications (GSM), Universal Mobile Telecommunications System (UMTS), Personal Communications Service (PCS), Time Division Multiple Access (TDMA), Code Division Multiple Access (CDMA), or other mobile network transmission technology. Again, any mobile electronic device that can communicate using a network interface can interface with a target system that utilizes concepts according to the present invention, such as laptop or other portable computers 116, mobile phones 118A and other mobile communicators, Personal Digital Assistants (PDA) 120, or any other similar computing device capable of communicating via the wireless network 114, as represented by generic device 122.

The message 102 may be transferred between devices using short-range wireless technologies 124, such as Bluetooth, Wireless Local Area Network (WLAN), infrared (IR), Universal Mobile Telecommunications System (UMTS), etc. The message 102 can also be distributed using direct wired connections, such as depicted by connection path 126. The present invention is applicable regardless of the manner in which the message 102 is provided or distributed between the target devices.

An example of a target device that utilizes concepts according to embodiments of the present invention is illustrated as the mobile phone 118B. The device 118B includes, for example, a radio transceiver 134 and hardware (including the processor) coupled to an operating system (OS) 130. The present invention may include a dispatcher 132 implemented as firmware, a module, or a program running on the OS 130. The dispatcher 132 can be used in any type of OS 130, including various versions of Windows®, Linux, Unix®, PalmOS®, Symbian OS, etc.

The target device 118B contains the ability to listen for incoming connections based on network protocols. Traditionally, the ability to listen and process incoming network data is provided by servers. For example, a server that provides telnet services on a Transmission Control Protocol/Internet Protocol (TCP/IP) network listens on TCP/IP port 23. When a client attempts to connect on port 23, a server application that understands the telnet protocol is used to process the session. Because sessions are initiated on the client terminal, clients traditionally have not needed to listen for incoming connections.

The nature of modern telecommunications has changed this communications scenario in some applications. For example, a mobile device that offers the ability to process an incoming telephone call requires the ability to listen for a connection somewhat like a server. Telecommunications devices such as cell phones have used their own specialized protocols for establishing voice and data connections. For example, cellular phone systems using the Global System for Mobile Communications (GSM) protocol provide voice and text messaging services to users with full roaming capabilities across the world.

With the advent of the Internet, mobile telecommunications devices such as cellular phones are being extended to handle Internet communications as well as voice and text messaging. As wireless technologies evolve, greater bandwidth will allow mobile devices to effectively handle a wide variety of Internet based data. As with voice communications, a useful feature desired in mobile devices is to accept incoming connections. This “push” internet technology has been used in a limited way on desktop computers, but is likely to be highly utilized on mobile devices given the two way communications nature of these devices.

There are potential problems when putting server-like functions on networked devices. One issue in providing server applications is the designation of what application handles what type of incoming data. In IP networks, this is typically dealt with by assigning specific transport layer (e.g. TCP) ports for particular functions, such as port 23 for telnet and port 80 for Hypertext Transfer Protocol (HTTP). Besides, TCP, the User Datagram Protocol (UDP) is also commonly used to listen for incoming data on IP networks. As with TCP/IP, pre-assigned UDP/IP ports are associated certain types of incoming data.

TCP and UDP ports are 16-bit unsigned integers embedded in the protocol headers. TCP and UDP ports may be well known or registered with the Internet Assigned Numbers Authority (IANA). Well-known ports (also referred to as system ports) range from 0 to 1023, and registered (or user) ports range from 1024 through 49151. Ports from 49152 through 65535 are private ports and can be dynamically allocated by any device for various uses. For example, well-known ports 80 and 23 are associated with HTTP and telnet, respectively.

One problem when using well-known or registered TCP/IP or UDP/IP ports is the limited number of system and user ports. In general, a developer of an application that listens for connections must be concerned about a port being available, both with IANA and on the user's device. Even though applications should only listen on registered or well known ports, applications may sometimes allow a process to listen on an arbitrary, user selectable port. Although user selectable ports may provide a short term workaround to port contention, it has some disadvantages. If an application is listening on an arbitrary port, other users or servers may not know which port has been selected, and therefore cannot connect. Selecting ports creates confusion on the part of the users, who generally shouldn't have do deal with concepts such as TCP/IP ports. Finally, using arbitrary ports may lead to contention for port number use.

The present invention is directed towards using a dispatching procedure to identify and deliver incoming data to the correct client application of a device. The dispatcher may examine data arriving on one or more network ports and within one or more protocols and determine the appropriate application for the data. In another arrangement, the dispatcher may act as a lookup service for other server applications to determine the correct disposition of incoming data.

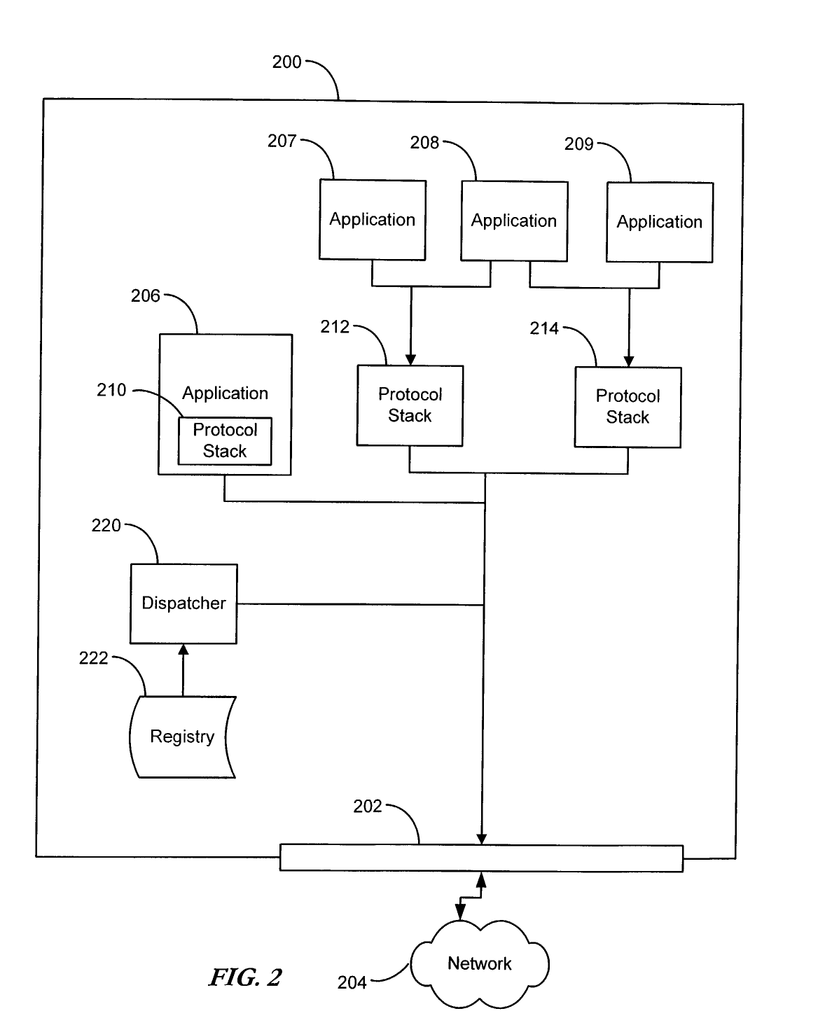

A diagram of a device 200 embodying concepts of the present invention is shown in FIG. 2. The device includes a network interface 202 for communicating over a network 204. The device 200 is enabled to run multiple applications 206, 207, 208, 209 that are able to receive incoming data from the network interface 202. The applications 206, 207, 208, 209 may provide any user or system function on the device 200. For example, applications can be used for receiving and presenting data for users, such as in a multimedia communication session. The application may use incoming data for system tasks, such as updating system time or network parameters.

One example application 206 contains its own protocol stack 210 for dealing with network communications. In general, the protocol stack 210 handles data formatting, sequencing, timing, and states of network communications. Most well known protocols such as HTTP or Session Initiation Protocol (SIP) have standardized, open rules to allow cross platform communications using the protocol. Other protocols may be less well known or proprietary. In general, the application's protocol stack 210 usually operates at or near the top (application) layer of the Open Systems Interconnection (OSI) networking model. The application layer protocols deal with application specific data and states. Lower layer OSI functions, such as transport, are usually handled by the operating system.

The device 200 may also include shared protocol stacks 212, 214. Shared protocol stacks 212, 214 allow multiple applications 207, 208, 209 to concurrently communicate using a protocol that may use a limited network resource such as a default port. Application 207 uses protocol stack 212 and application 209 uses protocol stack 214. Application 208 uses both protocol stacks 214, 212. Therefore FIG. 2 illustrates the situation where multiple applications share a single protocol stack, as well as where an application connects to multiple protocol stacks. These protocol stacks 212, 214 may exist as separately running processes or shared objects such as software libraries. If the protocol stacks 212, 214 are implemented as running processes, then the applications 207, 208, 209 that communicate with the protocol stacks may use some sort of Inter-Process Communications (IPC) mechanism.

IPC protocols often allow programmers to transparently invoke methods on remote processes by making function calls. The processes can define Application Program Interface (API) methods usable by another IPC aware processes. These API methods can be used to initiate events, transfer data, process queries, etc. In reference to FIG. 2, the applications 207, 208, 209 and protocol stacks 212, 214 can exchange network data using predefined API methods.

Although the application protocol stack 210 and independent protocol stacks 212, 214 may run different protocols, some protocol functionality may overlap. For example, the application 206 may use SIP to establish a multimedia session, therefore the application protocol stack 210 communicates using SIP. The shared protocol stack 214 may also communicate using SIP, providing functionality for such applications as presence or instant messaging. Therefore, it may not be clear which application is the recipient of an incoming SIP message. In general, the protocol stacks 210, 212, 214 will have to listen on different network ports, but it still may be the case that an incoming message on the default SIP port (5060) may be usable by any application 206, 207, 208, 209 of the device 200.

To better determine a destination for incoming data, the device 200 includes a dispatcher 220 to make determinations of incoming data. The dispatcher 220 may make determinations based on the transport layer characteristics (e.g. incoming port, transport protocol) and application layer characteristics (e.g. headers and application descriptors) of incoming data. The dispatcher 220 may rely on an application descriptor registry 222 to make determinations of existing application and how to best deal with incoming data.

Using a separate dispatcher 220 and registry 222 to oversee incoming network data offers numerous advantages over existing methods of handling incoming data. For example, if one application was a network chess game, the user would normally require the game to be running before anyone could remotely request to play a game with the user. If the chess game used a custom protocol, the device would have to reserve a registered network port or have the users pre-arrange a private port for use. If the chess game was designed to use an existing protocol such as SIP or HTTP, then there could be conflicts with other applications that use these protocols, as well as the duplicative effort in having to include all the protocol rules in the chess game.

In a device 200 utilizing a dispatcher 220, the chess game could register its capabilities and data formats in the registry 222. The chess game could use a reserved port monitored by the chess game itself or by the dispatcher 220. Therefore when a remote user wanted to initiate a chess game, the dispatcher 220 would receive notification of the incoming request on the reserved port, recognize the required application appropriate for the request by scanning the registry 222 and start the chess program. The actual chess session could continue to receive further messages on the reserved port, or a new private port could be randomly assigned for further chess game communications while the dispatcher 220 continues listening for incoming connections on the reserved port.

Other problems in having multiple applications vying for incoming data include the fact that multiple applications on the terminal can use the same protocol stack (SIP, HTTP, WSP, etc) as bearer. Those client applications can have a unique content type registered by IANA or other standardization forum (WAP Forum, etc). There could be a set of applications that use a generic content type so that it would be necessary to identify the right application based on other criteria. The application should register using this alternate criteria when indicating for which content the application is responsible.

It is possible that more than one client application can use a content type or format that is uniquely registered. Although the applications are interested on receiving the same format of message, that format may encapsulate different types of content. For example, message data is often encapsulated in Extensible Markup Language (XML). XML is a general purpose markup language for capturing data structures and relationships in an extensible and uniform way. XML can be used by many applications. In another example, multimedia data types included in incoming messages may be relevant for different applications that use Multimedia Message for exchanging different content.

Furthermore, multiple applications could be interested in receiving the same content but received using different protocols. Thus two separate applications could register to receive the same content type, but are registered to receive that content type using a different end-to-end protocol. This is possible, since the same Multipurpose Internet Mail Extensions (MIME) type can be transported within multiple protocols such as SIP, HTTP, Simple Mail Transport Protocol (SMTP), etc., but the applications interested on receiving that content are different. This problem is not always relevant when each application includes its own protocol stack. When multiple applications utilize a shared stack, a mechanism is required for differentiating the multiple applications.

One way of differentiating applications for incoming data involves using a Generic Application Descriptor (GAD). A GAD would be required for specifying the relevant information about the application. This relevant information may include the content type the application is expecting to receive, the protocols the application understands, and other logic used for decision making. These attributes could be formatted using XML. An example set of attributes for a messaging application could be as shown in Listing 1.

Listing 1

| | |
|---|---|
| App-Name = | Messaging |
| App-Version = | 1.0 |
| App-vendor = | Nokia |
| App-bearer = | SIP\|HTTP |
| Content-type = | plain/txt\|vnd.mms |
| bearer-descriptor = | SIP: MESSAGE\|HTTP: POST |
| bearer-logic = | SIP: header (Content-Disposition = app_ID)\| |
| | HTTP: header(Content-Type = vnd.mms) |

Other attributes can be included in the GAD such as security settings or the location of the executable file so a dispatcher 220 could automatically start the application. Applications can create a GAD that is uploadable to the registry 222 during installation on the device 200. Alternatively, the applications can dynamically create or update registry entries at runtime. The ability to dynamically update the registry 222 is useful when an application's functionality is extended through an upgrade or plug-in, for example.

When a dispatcher 220 is used to analyze incoming data, the dispatcher 220 may look at protocol headers and other parts of the message that relate to entries in the registry 222. For protocols such as SIP, HTTP, and SMTP, the protocols may use MIME headers and other content descriptive headers. This data can be embedded in the content of the message, such as by using XML tags to encapsulate the data. Where the application receives incoming messages from multiple protocol stacks, the dispatcher may utilize the application descriptor data in the messages that include the protocol bearer (one or many), ports, content-type and the other indicators of bearer logic. These indicators of bearer logic can contain additional information such as application ID (or some similar ID) and parameters included in some headers or URI of the selected protocol bearer.

It is appreciated that there are a wide range of devices and ways of implementing a dispatcher 220 and registry 222. In one example, the dispatcher 220 and registry 222 can be implemented as part of the Java™ Micro Edition (J2ME) Mobile Information Device Profile (MIDP). MIDP is a run-time environment for Java applications on mobile devices. MIDP interfaces with the Connected Limited Device Configuration (CLDC) virtual machine environment. CLDC may use any CLDC compliant virtual machine, such as the K virtual machine (KVM) or CLDC HotSpot virtual machine for interpreting Java on mobile devices.

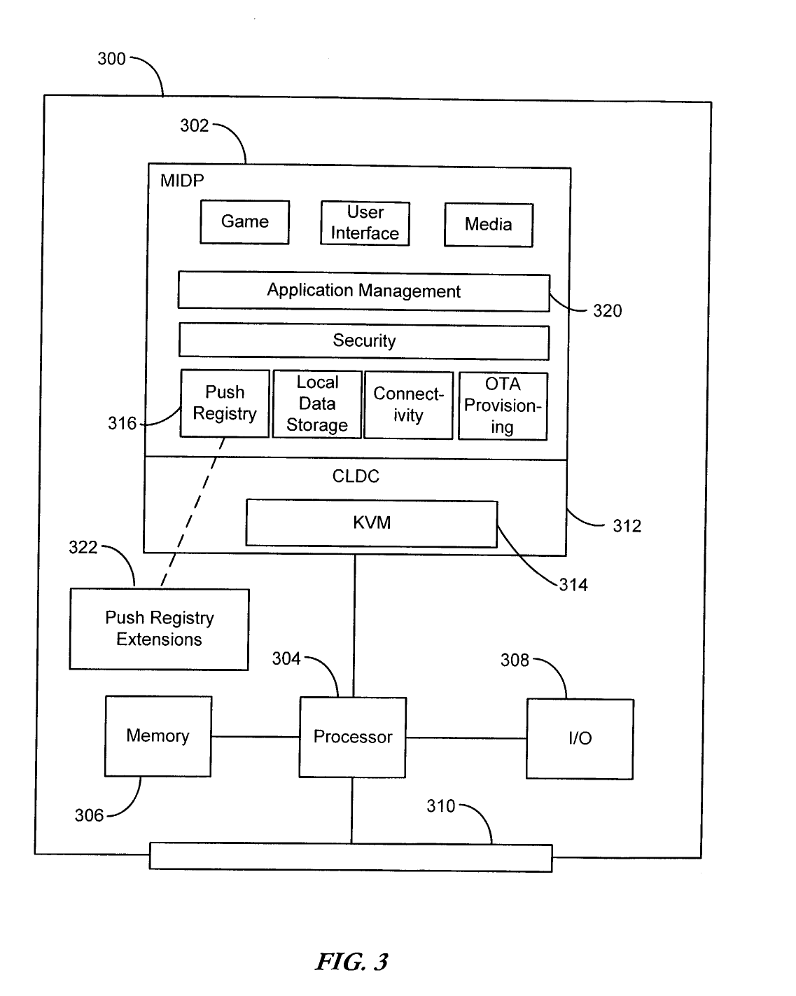

FIG. 3 shows a device 300 utilizing MIDP 302. The device 300 includes a processor 304, memory 306, an input/output (I/O) bus 308, and a network interface 310. In this example, MIDP 302 interfaces with CLDC 312 using the KVM 314. As part of the current MIDP 2.0 specification, the MIDP 302 contains a push mechanism known as the PushRegistry 316 that allows network transmission to be initiated by another system or device. To receive a pushed message, push attributes must be registered with the PushRegistry service class.

The PushRegistry mechanism is controlled by the Application Management Software (AMS) 320 to receive incoming data and start the appropriate application. Applications (also known as MIDlets under MIDP) can register to listen to data from certain combinations of incoming connection Uniform Resource Locators (URLs) and sending hosts. The connection URL includes specifications of the incoming transport (e.g. UDP datagram, TCP socket) as well as port number.

Registered push connections are subject to rules, most of which are to resolve conflicts of two or more MIDlets needing the same type of connection and security issues of an unknown system contacting the device. In general, for the PushRegistry to work, the sender must know beforehand the protocol and port the receiving side is setup to receive.

In a device 300 according to the present invention, extensions 322 to the PushRegistry 316 can be used to enable a dispatcher. Currently, MIDlets to be installed on a device 300 come with a Java Application Descriptor (JAD) file. The JAD file includes entries such as “MIDlet-Name”,“MIDlet-Version”, “MIDlet-Vendor”, etc. These entries in the JAD file can be used by the operating system installer to manage the MIDlet and by the MIDlet itself for holding configuration specific attributes. These entries can be extended for use by the PushRegistry 316 to enable dispatching data based on MIDlet protocols and capabilities.

For example, using the chess game example, the JAD file would traditionally contain entries such as those in Listing 2.

Listing 2

| | |
|---|---|
| MIDlet-Name: | Chess network Midlet |
| MIDlet-Version: | 1.1 |
| MIDlet-Vendor: | Nokia |
| MIDlet-1: | Chess application, /Chess.png, com.Nokia. |
| | applications.chess |
| MicroEdition- | MIDP-2.0 |
| Profile: | |
| MicroEdition- | CLDC-1.0 |
| Configuration: | |

This JAD file could be extended with the following example entries shown in Listing 3.

Listing 3

| | |
|---|---|
| Midlet-supported- | SIP |
| protocols: | |
| Midlet-protocol- | MESSAGE |
| features: | |
| Midlet-protocol- | Contact: * Application = /Nokia/appl/chess |
| parameters: | |
| MIDlet-push-1: | sip://:5060, application-type = /Nokia/appl/chess, |
| | com.Nokia.applications.chess,* |

The example JAD entries in Listing 3 provide the AMS with further protocols and capabilities supported by the MIDlet. The “Midlet-supported-protocols” contains a list of protocols that the MIDlet supports. The “Midlet-protocol-features” indicates features (e.g. methods) of the protocols that are supported. The “Midlet-protocol-parameters” contains parameter type-value pairs applicable to the protocol. Finally, the “MIDlet-push” entry has an “application-type” identifier that is used by the PushRegistry framework to identify the type of application.

By using the “application-type” identifier, the PushRegistry framework could handle multiple applications that may use the same incoming port and protocol. When receiving an incoming message, the AMS could read attribute descriptors of the incoming message (whether within the body of the message, within PushRegistry specific data portions, or elsewhere) and send the message to the correct MIDlet based on those descriptors.

Although the previous example used the default SIP network port of 5060 for processing incoming messages, it is appreciated that the PushRegistry framework can use any network port. In one arrangement, a specific unused port could be registered for Java PushRegistry use. Messages received on the PushRegistry port could have attribute descriptor data embedded in the messages or as part of data passed by the PushRegistry mechanism. In this way, a MIDlet using a network protocol would not have to worry about reserving a particular network port. Since all messages would be delivered based on attribute descriptors, the MIDlet can safely assume that the PushRegistry framework will handle the incoming connections.

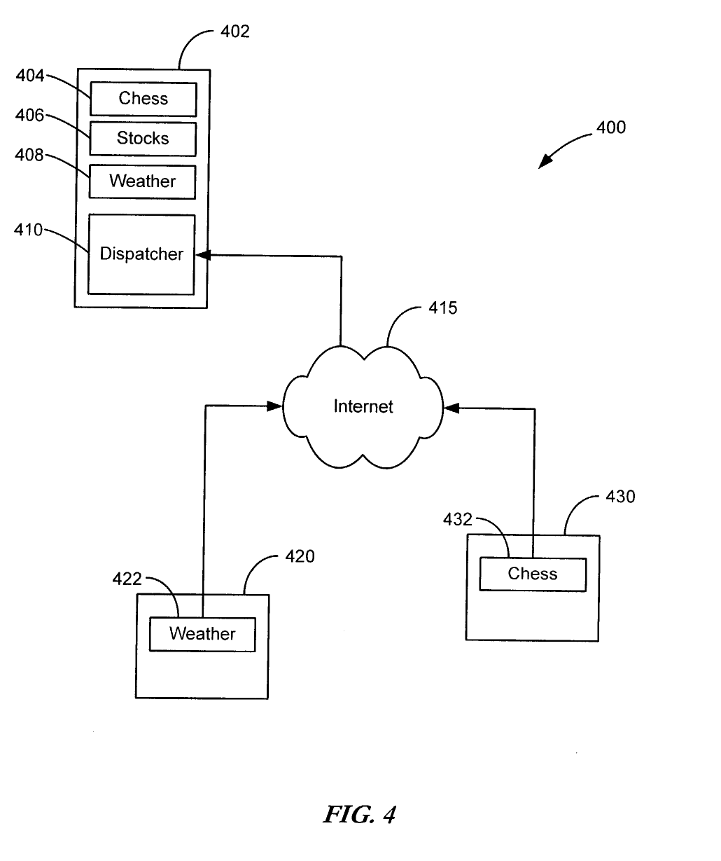

FIG. 4 shows an example system 400 utilizing concepts according to embodiments of the present invention. A user device 402 contains three software applications, a chess game 404, a stock ticker 406, and a weather alert application 408. The user device 402 could be a wireless terminal or any other mobile or fixed computing device. The applications 404, 406, 408 could be Java MIDlets or any other type of user program. The device includes a dispatcher 410 for determining application descriptors of incoming messages. The dispatcher 410 could directly receive and examine the messages, or the dispatcher could be a module accessed by some other message receiving process. For example, if the device 402 was running MIDP, the messages might be received by the PushRegistry framework, and the dispatcher 410 could integral or added as an extension to that framework.

The device 402 is connected to the Internet 415. Also connected to the Internet 415 is a weather data server 420 and another user device 430. The weather data server 420 includes a weather service application 422 that is tied into national weather reporting systems and can determine the location of the user device 402. The second user device 430 includes a chess game 432 that is compatible with the first user's chess game 404.

For this example, it is assumed that all three applications 404, 406, 408 on the user device 402 rely on the SIP messaging protocol. Although SIP is often used for setting up multimedia sessions, SIP can also be used for carrying data for services such as text messaging, or maintaining user presence data. Other protocols such as HTTP may also be used to transfer data in a similar manner.

The user of the device 402 would like to be alerted when there are dangerous weather conditions. The weather server 420 keeps track of this preference, and when a dangerous weather condition is detected, the server 420 sends a SIP message. The device 402 receives the incoming message, where it is determined by the dispatcher 410 that the “application-type” is /WeatherSource/appl/alert. Depending on the system configuration, the incoming message may be received by a process such as a shared protocol stack (not shown), the dispatcher 410, or an application 422. It is appreciated that one or all of these processes may be simultaneously listening on a device 402 according to embodiments of the present invention. In general, the device 402 can be arranged that the processes receive messages forwarded from the dispatcher 410, or the device 402 can be arranged so that processes receive the messages themselves and use the dispatcher 410 to identify the destination application.

When identifying the weather application 422 as the destination in this example, it is also possible that the weather application 422 had previously determined that it would handle the messages received with SIP and content-type plain text, but that the messages would include some tag or parameter in the Content-Disposition header (e.g. App-Name=/WeatherSource/appl/alert, App-Version=1.0, App-vendor=Nokia, App-bearer=SIP, Content-type=plain/txt, bearer-descriptor=SIP:MESSAGE, bearer-logic=SIP:header(Content-Disposition=app_ID), etc). At least some of these tags would be present both in the registry of the dispatcher 410 and in the incoming message.

After determining the weather application 408 is the correct destination for the incoming message, the dispatcher 410 can start the weather application 408 if it is not already running. The weather application 408 can display the incoming data as an alert along with an animated map or other relevant data.

In another example, the user of the second device 430 may want to initiate a chess game with the user of the first device 402. The second device 430 sends a SIP message which is received at the first device 402. The dispatcher 410 determines the “application-type” is /Nokia/appl/chess, and the user is then prompted asking whether they would like to play a game of chess.

Although an application descriptor such as “application-type” has been described by way of example, it is appreciated there are various other ways to identify applications. As previously mention, protocols supported by the application as well as features and parameters of those protocols might also be used to determine the appropriate application. Other descriptive header fields such as those used in SIP messages may also be advantageously utilized. Such fields as Content-Disposition, Content-Encoding, Accept-Contact, Content-Type, Event, etc., may provide further granularity when identifying target applications. It is appreciated that there may be overlaps in application abilities. For example, an incoming sound file might be readable by both a browser and an MP3-player program. The dispatcher would typically include ways of ranking applications by order of preference, or by other content data.

Using the description provided herein, the invention may be implemented as a machine, process, or article of manufacture by using standard programming and/or engineering techniques to produce programming software, firmware, hardware or any combination thereof. Any resulting program(s), having computer-readable program code, may be embodied on one or more computer-usable media such as resident memory devices, smart cards or other removable memory devices, or transmitting devices, thereby making a computer program product or article of manufacture according to the invention. As such, “computer readable mediums” as used herein are intended to encompass a computer program that exists permanently or temporarily on any computer-usable medium or in any transmitting medium which transmits such a program.

As indicated above, memory/storage devices include, but are not limited to, disks, optical disks, removable memory devices such as smart cards, SIMs, WIMs, semiconductor memories such as RAM, ROM, PROMS, etc. Communication mediums include, but are not limited to, communications via wireless/radio wave communication networks, the Internet, intranets, telephone/modem-based network communication, hard-wired/cabled communication network, satellite communication, and other stationary or mobile network systems/communication links.

From the description provided herein, those skilled in the art are readily able to combine software created as described with appropriate general purpose or special purpose computer hardware to create a data processing device and/or computer subcomponents embodying the invention, and to create a data processing device and/or computer subcomponents for carrying out the method of the invention.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

What is claimed is:

1. A method of processing an incoming application data for a plurality of applications, the method comprising:
communicating an application descriptor of each of the plurality of applications to a registry;
receiving the incoming application data at a network interface;
identifying a destination application from the plurality of applications based on an application descriptor of the incoming application data and the registry; and
communicating the incoming application data to the destination application.

2. The method of claim 1, further comprising starting the destination application if the destination application is not running.

3. The method of claim 1, wherein identifying the destination application comprises examining a message header of the incoming application data.

4. The method of claim 1, wherein the application descriptor of each of the plurality of applications comprises a content-type attribute that describes a content format receivable by the applications.

5. The method of claim 1, wherein the application descriptor of each of the plurality of applications comprises an application-type attribute that describes applications suitable for receiving the incoming application data.

6. The method of claim 1, wherein the application descriptor of each of the plurality of applications comprises a protocol attribute that describes a network protocol usable by the applications.

7. The method of claim 1, wherein communicating the application descriptor of each of the plurality of applications to the registry comprises communicating to a Java PushRegistry.

8. A communications device, comprising:
a persistent data storage comprising an application descriptor registry;
a network interface configured to receive an incoming application data; and
a processor arranged to:
receive the incoming application data from the network interface,
identify a destination application of the communications device based on the application descriptor registry and an application descriptor of the incoming application data; and
communicate the incoming application data to the destination application.

9. The communications device of claim 8, wherein the processor is further arranged to start the destination application if the destination application is not running.

10. The communications device of claim 8, wherein the processor is further arranged to identify the destination application by examining a message header of the incoming application data.

11. The communications device of claim 8, wherein the application descriptor registry comprises a content-type attribute that describes content formats receivable by applications.

12. The communications device of claim 8, wherein the application descriptor registry comprises an application-type attribute that describes applications suitable for receiving the incoming application data.

13. The communications device of claim 8, wherein the application descriptor registry comprises a protocol attribute that describes network protocols usable by applications.

14. The communications device of claim 8, wherein the communications device comprises a mobile terminal.

15. The communications device of claim 8, wherein the network interface comprises a wireless network interface.

16. A computer-readable medium for processing an incoming application data for a plurality of applications of a computing device having a network interface and a registry, the computer readable medium configured with instructions for causing the computing device to perform the steps of:
communicating an application descriptor of each of the plurality of applications to the registry of the computing device;
receiving the incoming application data at the network interface of the computing device;
identifying a destination application of the plurality of applications based on an application descriptor of the incoming application data and the registry; and
communicating the incoming application data to the destination application.

17. The computer readable medium of claim 16, wherein the computer readable medium is further configured with instructions for causing the computing device start the destination application if the destination application is not running.

18. The computer readable medium of claim 16, wherein identifying the destination application comprises examining a message header of the incoming application data.

19. The computer readable medium of claim 16, wherein the application descriptor of each of the plurality of applications comprises a content-type attribute that describes a content format receivable by the applications.

20. The computer readable medium of claim 16, wherein the application descriptor of each of the plurality of applications comprises an application-type attribute that describes applications suitable for receiving the incoming application data.

21. The computer readable medium of claim 16, wherein the application descriptor of each of the plurality of applications comprises a protocol attribute that describes a network protocol usable by the applications.

22. The computer readable medium of claim 16, wherein communicating the application descriptor of each of the plurality of applications to the registry of the computing device comprises communicating to a Java PushRegistry.

23. The computer readable medium of claim 16, wherein the computing device comprises a mobile terminal.

24. The computer readable medium of claim 16, wherein the network interface comprises a wireless interface.

25. A system for communicating an application data over a network, comprising:
a first computing device comprising a network interface coupled to the network for sending the application data; and
a second computing device comprising:
a persistent data storage comprising an application descriptor registry;
a network interface coupled to the network and configured to receive the application data; and
a processor arranged to:
receive the application data from the network interface;
identify a destination application of the second computing device based on the application descriptor registry and an application descriptor of the application data; and
communicate the application data to the destination application. communicate the incoming application data to the destination application.

26. The system of claim 25, wherein the processor of the second computing device is further arranged to start the destination application if the destination application is not running.

27. The system of claim 25, wherein the processor of the second computing device is further arranged to identify the destination application by examining a message header of the application data.

28. The system of claim 25, wherein the application descriptor registry of the second computing device comprises a content-type attribute that describes content formats receivable by applications.

29. The system of claim 25, wherein the application descriptor registry of the second computing device comprises an application-type attribute that describes applications suitable for receiving the application data.

30. The system of claim 25, wherein the application descriptor registry of the second computing device comprises a protocol attribute that describes network protocols usable by applications.

31. The system of claim 25, wherein the second computing device comprises a mobile terminal.

32. The system of claim 25, wherein the network interface of the second computing device comprises a wireless network interface.

33. The system of claim 25, wherein the first computing device comprises a mobile terminal.

34. The system of claim 25, wherein the first computing device comprises a server.
